(19) United States
(12) Patent Application Publication
(10) Pub. No.: US 2011/0239371 A1
(43) Pub. Date: Oct. 6, 2011

(54) SWINGING WATER MASSAGE BED

(75) Inventors: CHUN-FA SHAO, TAOYUAN COUNTY 324 (TW); PO-CHIN SHAO, TAOYUAN COUNTY 324 (TW); CHANG-MING HU, KAOHSIUNG CITY 811 (TW); MING-FENG WU, KAOHSIUNG CITY 811 (TW); TSUNG-YI LIN, KAOHSIUNG CITY 811 (TW)

(73) Assignee: CHUN-FA SHAO, TAOYUAN COUNTY 324 (TW)

(21) Appl. No.: 12/749,720

(22) Filed: Mar. 30, 2010

(51) Int. Cl. A47C 27/08; A61H 7/00

(52) U.S. Cl. 5/670; 601/148

(57) ABSTRACT

The present invention is to provide a swinging water massage bed for a user to lie on a bed board. The user can operate a controller to ascend the bed board and swing the bed board through a swing driving unit, or descend the bed board to a resilient layer of a water container. With a water jet device in the water container, water jets out to knock against the resilient layer for the user to be massaged so as to help the user sleep or relax.

### BACKGROUND OF THE INVENTION

1. Field of the Invention

The present invention relates to a swinging water massage bed, and more particularly to one that has a swing driving unit and a water jet device for the user to relax his/her body.

2. Description of the Prior Art

A conventional water massage bed, developed by Japanese Minato Medical Science Co., Ltd, is used for treatment. The user lies on an elastic bed to be massaged through a jet apparatus under the elastic bed. The jet apparatus jets liquid in an intermittence or continuity way to knock against the elastic bed for the user to be massaged. This type of water massage bed cannot be used for a long time because the water jetted from the jet apparatus is too strong. The elastic bed is unable to ease the impact. It is uncomfortable for the user to bear the impact of the water, so the time must be limited when in use. The preferable is once in a period of time, avoiding the user form hurt. The water massage bed designed by Minato Medical Science Co., Ltd. is often used in a clinic or hospital for treatment. This water massage bed is not suitable for a household apparatus because it is too expensive.

Moreover, a household water massage bed only has a single function. To consider the price, it is unable to add other functions. This type of water massage bed is hard to attract consumers. Accordingly, the inventor of the present invention has devoted himself based on his many years of practical experiences to solve this problem.

### SUMMARY OF THE INVENTION

The present invention is to provide a swinging water massage bed, which comprises a bed frame and a bed board disposed on the bed frame. The bed board has a pair of holders to be connected to shift devices on support posts of the bed frame. The holders can be moved up and down through an ascent-descent driving unit so as to ascend or descend the bed board. The bed frame and the bed board are provided with a swing driving unit to swing the bed board sideward. The present invention further comprises a water container having a water jet device under the bed board.

The bed board is covered with a net for the user to lie on the bed board. With a controller, the user can operate the ascent-descent driving unit, the swing driving unit and the water jet device. The water jetted from the water jet device knocks against a resilient layer on the water container. The ascent-descent driving unit can descend the bed board to the resilient layer for the user to lean on the resilient layer, such that the user can be massaged through the water jetted from the water jet device. The user can control the swing driving unit to swing the bed board sideward to help the user sleep. It is noted that the swing driving unit must be operated after the bed board departs from the water container to avoid any interference.

A first object of the present invention is to provide a swinging water massage bed, which can prevent a person who lies on the bed for a long time from having a bedsore. The water jetted from the water jet device to knock against the resilient layer for the person lying on the resilient layer to be massaged. Besides, a jet nozzle of the water jet device can be at different angles and different positions along with the movement of a guide rod and the turning of a second platform of the water jet device, providing a multi-direction massage.

A second object of the present invention is to provide a swinging water massage bed, which can swing the bed board sideward for the user to relax his/her body. The user can start the swing driving unit to swing the bed board sideward after the bed board is lifted by the ascent-descent driving unit disposed on the bed frame. The swing driving unit comprises coils and a magnet. The coils are electrified to generate magnetic force to attract the magnet, such that the bed board can swing sideward. Alternatively, the swing driving unit comprises a compact oil cylinder to push the bed board directly.

A third object of the present invention is to provide a swinging water massage bed, which can ease the impact force of the water jetted by the water jet device. The water container can be poured with compressed air to expand the resilient layer.

### BRIEF DESCRIPTION OF THE DRAWINGS

FIG. 1 is an exploded view of the present invention;

FIG. 2 is an enlarged view showing the shift devices of the present invention;

FIG. 3 is an enlarged view showing the holders of the bed strand of the present invention;

FIG. 4 is a side view of the present invention;

FIG. 5 is a schematic view showing another embodiment of the ascent-descent driving unit of the present invention;

FIG. 6 is a schematic view showing the swing driving unit of the present invention;

FIG. 7 is a schematic view showing the water container and the water jet device of the present invention;

FIG. 8 is a schematic view showing the water jet device of the present invention;

FIG. 9 is a schematic view of the present invention when in use;

FIG. 10 is a schematic view showing the ascent/descent driven by ascent-descent driving unit of the present invention;

FIG. 11 is another schematic view showing the ascent/descent driven by ascent-descent driving unit of the present invention;

FIG. 12 is a schematic view showing the swing driving unit of the present invention in an operating status;

FIG. 13 is a schematic view showing the present invention in an operating status; and

FIG. 14 is a schematic view showing another embodiment of the swing driving unit of the present invention.

### DETAILED DESCRIPTION OF THE PREFERRED EMBODIMENTS

Embodiments of the present invention will now be described, by way of example only, with reference to the accompanying drawings.

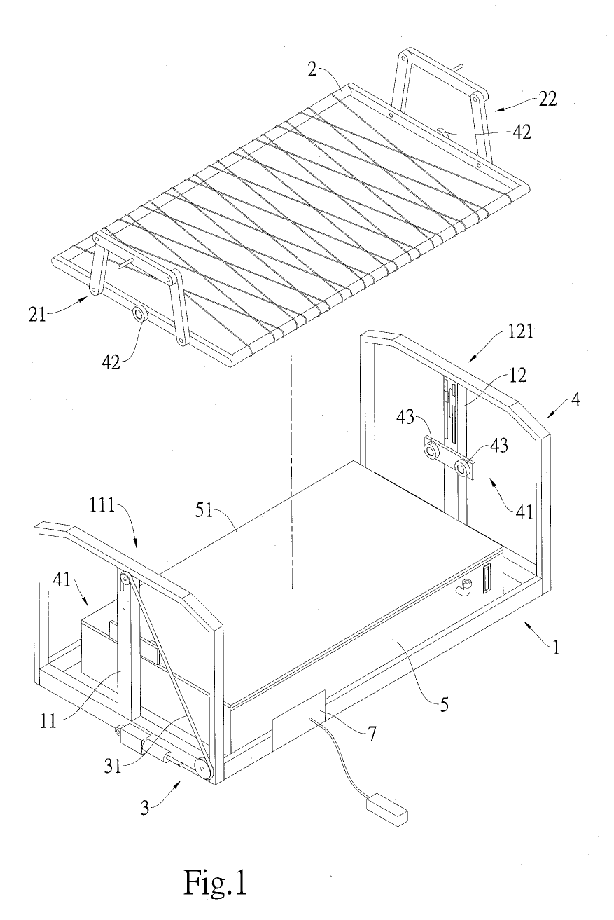

As shown in FIG. 1, a swinging water massage bed according to a preferred embodiment of the present invention comprises a bed frame 1 and a bed board 2.

The bed frame 1 is a frame. The bed frame 1 comprises two support posts 11, 12 at two ends thereof. The two support posts 11, 12 correspond in position to each other, and have shift devices 111, 121 on the support posts 11, 12, respectively.

The bed board 2 is also a frame corresponding in shape to the bed frame 1. The bed board 2 comprises holders 21, 22 at two ends thereof. The holders 21, 22 are connected to the shift devices 111, 121, respectively. In this way, the bed board 2 is moved up and down along with the shift devices 111, 121 relative to the support posts 11, 12.

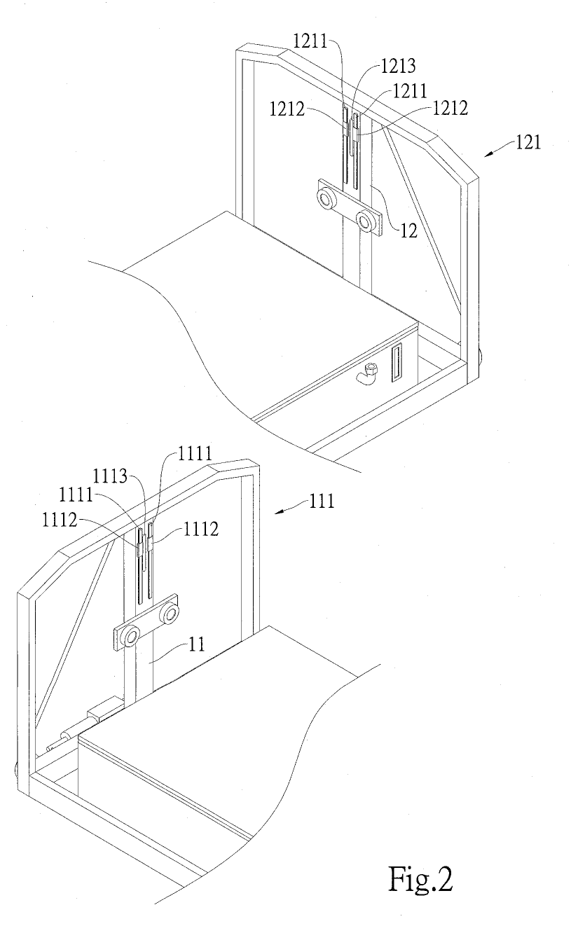

As shown in FIG. 2, the shift devices 111, 121 include slide rails 1111, 1211, slide blocks 1112, 1212, and slots 1113, 1213. The slots 1113, 1213 are disposed on upper ends of the support posts 11, 12, respectively. The slide rails 1111, 1211 are located beside the slots 1113, 1213, respectively. The slide blocks 1112, 1212 are placed on the slide rails 1111, 1211, respectively, to slide relative to the slide rails 1111, 1211. The slide rails 1111, 1211 and the slots 1113, 1213 are longitudinally disposed on the support post 11, 12.

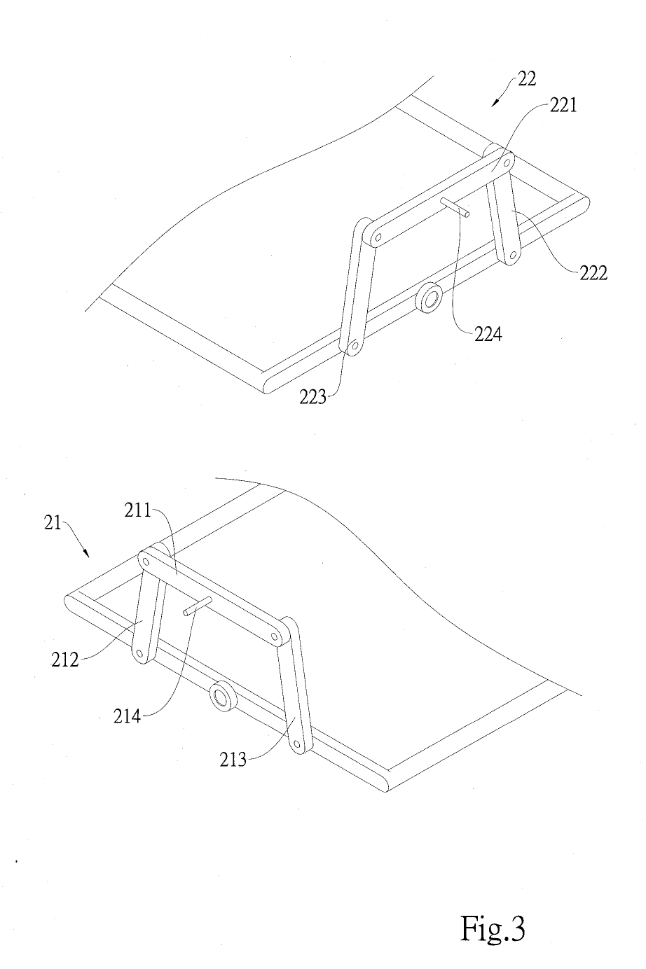

Referring to FIG. 1 to FIG. 3, the holders 21, 22 include first rods 211, 221, second rods 212, 222 and third rods 213, 223. The first rods 211, 221 are mounted on the slide blocks 1112, 1212 and transversely arranged with respect to the slide rails 1111, 1211, namely, the first rods 211, 221 are perpendicular to the slide rails 1111, 1211 as well as the slots 1113, 1213. Two ends of each of the first rods 211, 221 are pivotally connected to first ends of the second rods 212, 222 and the third rods 213, 223, respectively. Second ends of the second rods 212, 222 and the third rods 213, 223 are pivotally connected to the bed board 2, respectively. The second rods 212, 222 and the third rods 213, 223 can be moved rightward or leftward in the same direction to swing the bed board 2 sideward. The first rods 211, 221 are provided with struts 214, 224 which protrude from the first rods 211, 221. The struts 214, 224 are adapted to be inserted in the slots 1113, 1213.

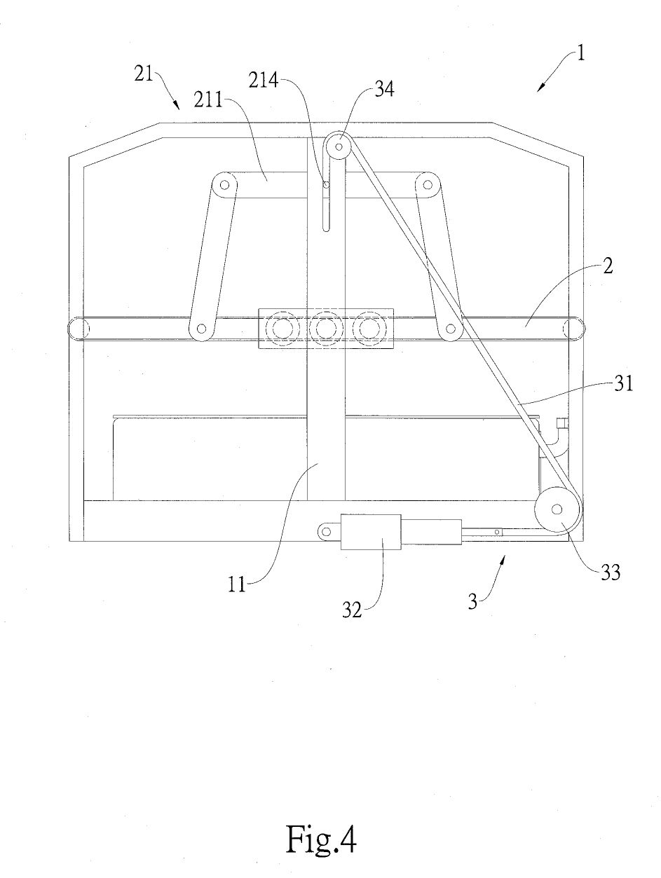

Referring to FIG. 4, one of the two ends of the bed frame 1 is coupled with a ascent-descent driving unit 3. The ascent-descent driving unit 3 is connected with the holder 21 through a power driving belt 31, namely, the ascent-descent driving unit 3 is connected with the strut 214 of the first rod 211, so that the holder 21 is longitudinally pulled by the ascent-descent driving unit 3 through the power driving belt 31 to ascend or descend the bed board 2 relative to the support posts 11, 12. Furthermore, the ascent-descent driving unit 3 includes an oil cylinder 32, a first driving wheel 33 and a second driving wheel 34. The oil cylinder 32 is disposed at a lower end of the support post 11. The first driving wheel 33 is disposed close to the oil cylinder 32. The second driving wheel 34 is disposed at the upper end of the support post 11. The power driving belt 31 is connected with the oil cylinder 32, wound on the first driving wheel 33 and the second driving wheel 34, and connected to the strut 214. According to the aforesaid, the bed board 2 can be ascended or descended.

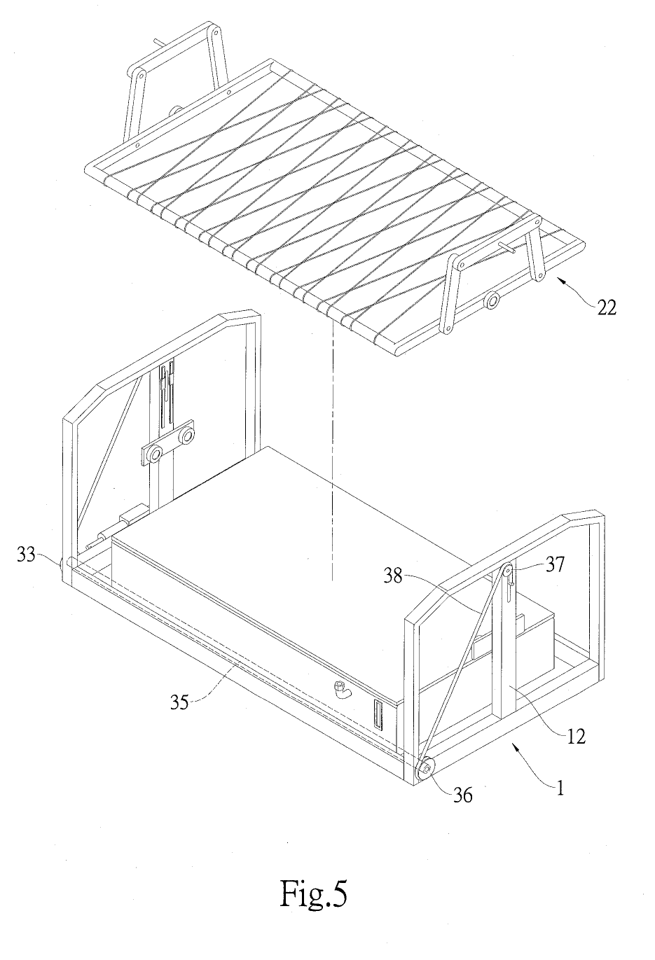

Referring to FIGS. 4 and 5, the first diving wheel 33 is connected with one end of a driving shaft 35. The driving shaft 35 penetrates one side of the bed frame 1. An opposing end of the driving shaft 35 is connected with a third driving wheel 36 which is located at the other end of the bed frame 1, where the support post 12 is located thereon. The upper end of the support post 12 is connected with a fourth driving wheel 37. A second power driving belt 38 is connected with the third driving wheel 36, the fourth driving wheel 37 and the holder 22. By the aforesaid structure, the ascent-descent driving unit 3 is stable to ascend or descend the bed board 2.

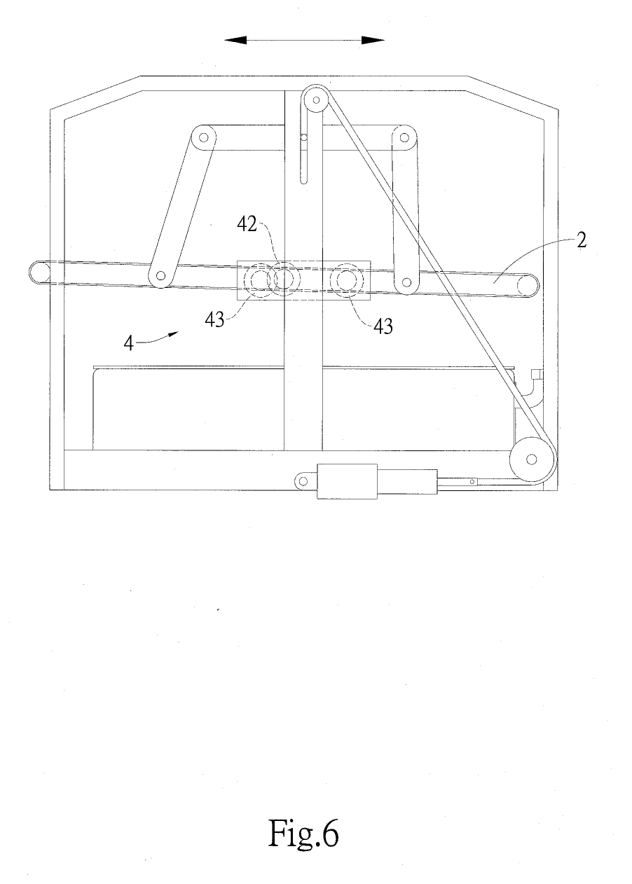

Referring to FIG. 1, the bed board 2 of the swinging water massage bed of the present invention uses a pair of swing driving units 4 to swing sideward. Each of the swing driving units 4 includes a coil set 41 and a magnet 42. The coil sets 4 of the swing driving units 4 are disposed on the support posts 11, 12. The magnets 42 of the swing driving units 4 are disposed on the two ends of the bed board 2. The coil set 41 has two coils 43 located at two sides of each of the support posts 11, 12. When the bed board 2 is connected to the bed frame 1, the magnet 42 will be located between the two coils 43. When the coils 43 are electrified to generate magnetic force, the two coils 43 will attract the magnet 42 by turns to swing the bed board 2 sideward, as shown in FIG. 6.

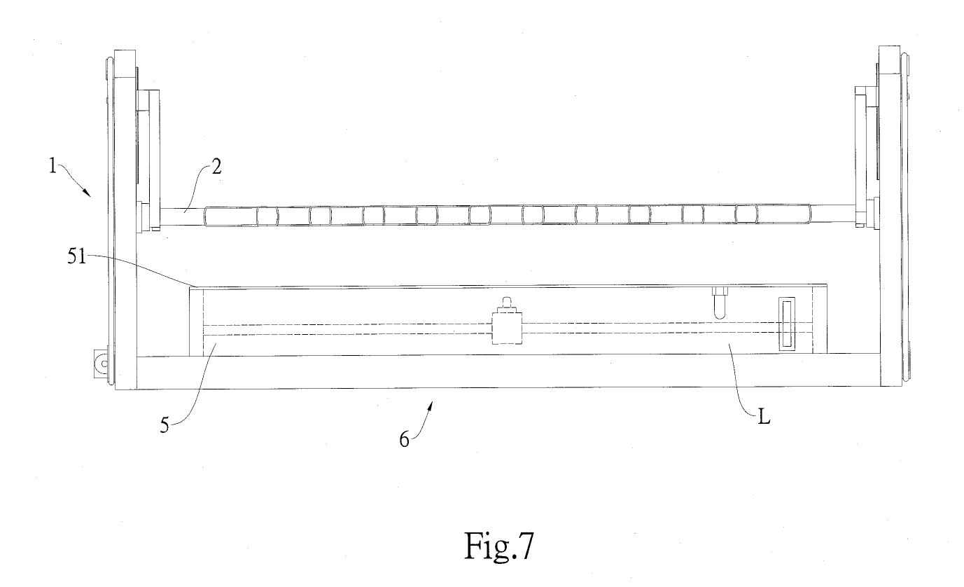

Referring to FIG. 7, the present invention further comprises a water container 5. The water container 5 corresponds in shape to the bed frame 1 and the bed board 2. The water container 5 is located under the bed board 2. The water container 5 is filled with liquid L, such as water. A water jet device 6 is provided in the water container 5. The water container 5 is covered with a resilient layer 51, such as a rubber sheet or a resilient film. When in use, the liquid L in the container 5 jets out through the water jet device 6 to knock against the resilient layer 51 on the water cylinder 5.

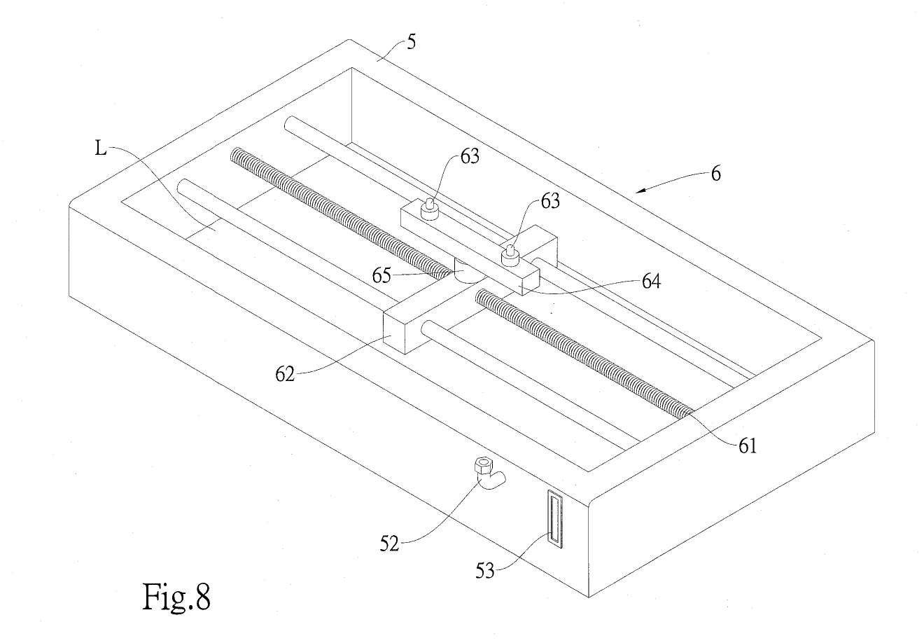

Referring to FIG. 8, the water jet device 6 comprises a guide rod 61, a first platform 62, and at least one jet nozzle 63. The guide rod 61 is longitudinally disposed in the water container 5. The first platform 62 is mounted on the guide rod 61 to move along the guide rod 61. The jet nozzle 63 is mounted on the first platform 62.

Furthermore, a second platform 64 is provided between the first platform 62 and the jet nozzle 63. The jet nozzle 63 is disposed on the second platform 64. A motor 65 is connected to the second platform 64. The first platform 62 and the second platform 64 are driven to turn by the motor 65.

As shown in FIG. 1 and FIG. 8, a controller 7 is electrically connected with the ascent-descent driving unit 3, the swing driving unit 4 and the water jet device 6.

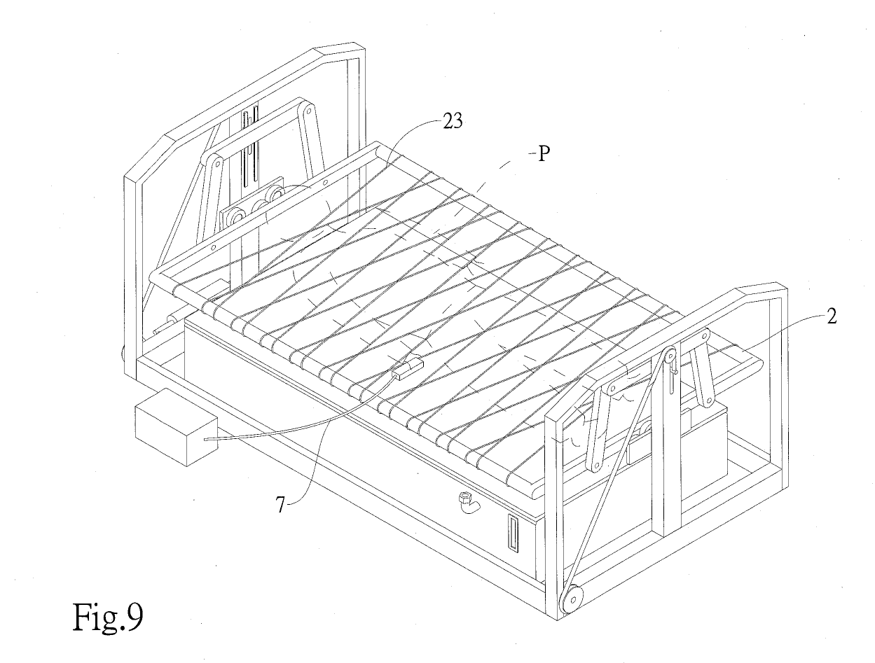

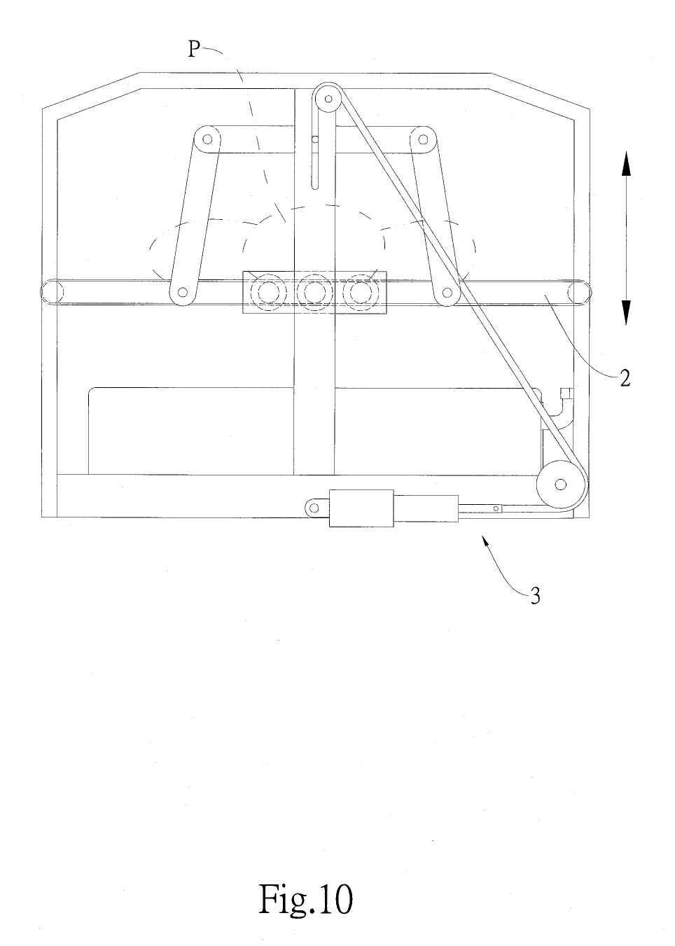

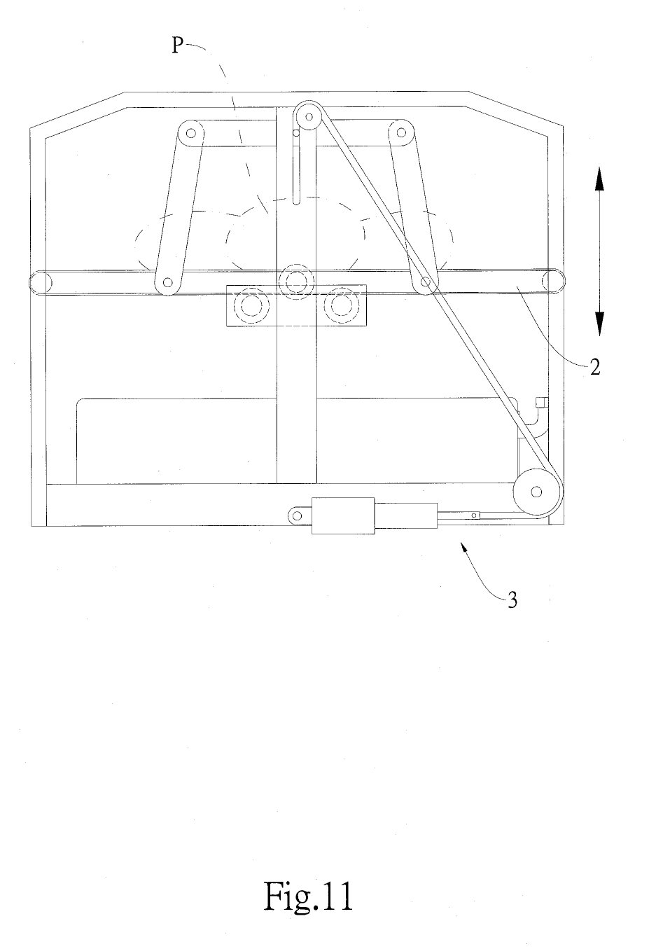

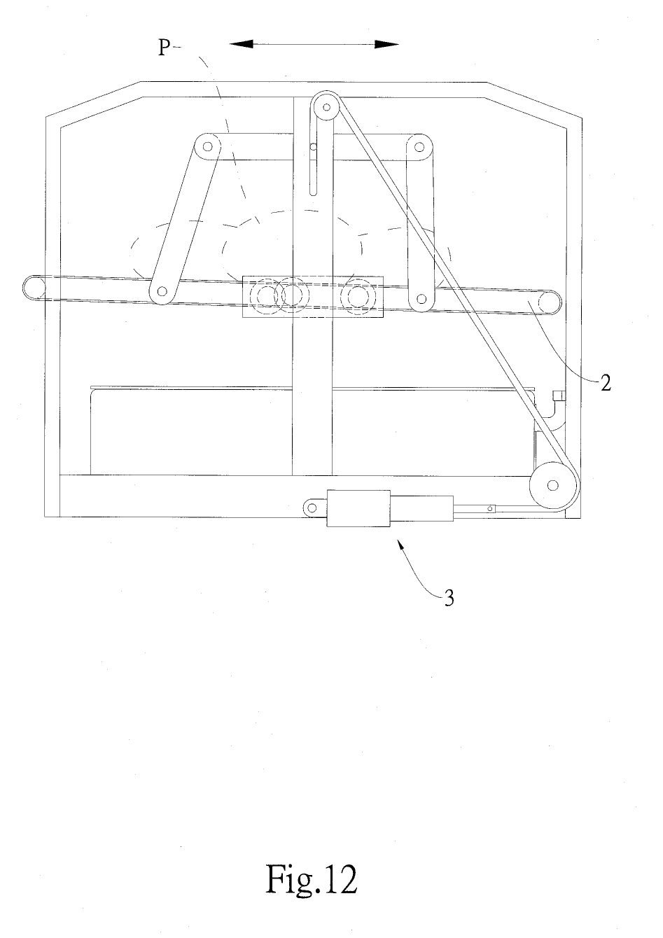

To operate the water massage bed of the present invention, as shown in FIG. 9 to FIG. 11, a net 23 is used to wrap the bed board 2 for a user P to lie on the net 23. The user P operates the controller 7 to control the ascent-descent driving unit 3 to ascend or descend the bed board 2. After the magnets 42 on the bed board 2 correspond to the coils 43 on the support posts 11, 12, the swing driving unit 4 is actuated to swing the bed board 2 so as to help the user P sleep or relax, as shown in FIG. 12.

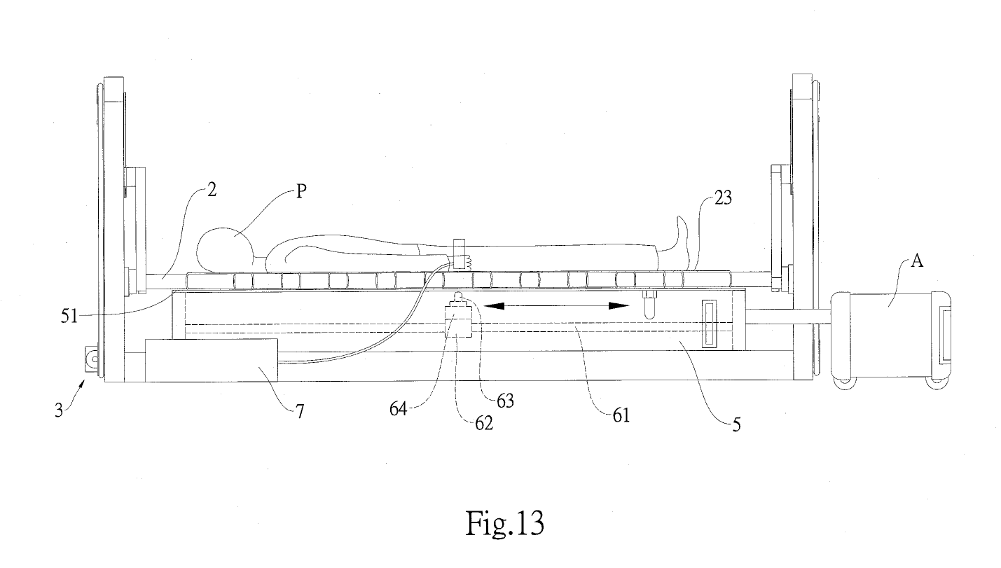

As shown in FIG. 13, the user P operates the ascent-descent driving unit 3 to descend the bed board 2 to the water container 5. The net 23 is to cover the resilient layer 51 for the user P to lie on the resilient layer 51 through the net 23. When the water jet device 6 is started, water jets out from the jet nozzle 63 to knock against the resilient layer 51 and the first platform 62 is moved along with the guide rod 61 so as to massage the user P on the resilient layer 51. The second platform 64 is driven by the motor 65 to levelly turn relative to the first platform 62, as shown in FIG. 8, so that the water jets out to knock against different position of the resilient layer 51 to massage different regions of the user's body.

Referring to FIG. 8, one side of the water container 5 is formed with a water inlet 52 for the user to pour the liquid L. A water level gauge 53 is provided beside the water inlet 52 for measuring the level of the liquid L in the water container 5.

As shown in FIG. 13, the water container 5 is connected with an air compressor A to input compressed air which expands the resilient layer 51 to ease the water force of the water against the user.

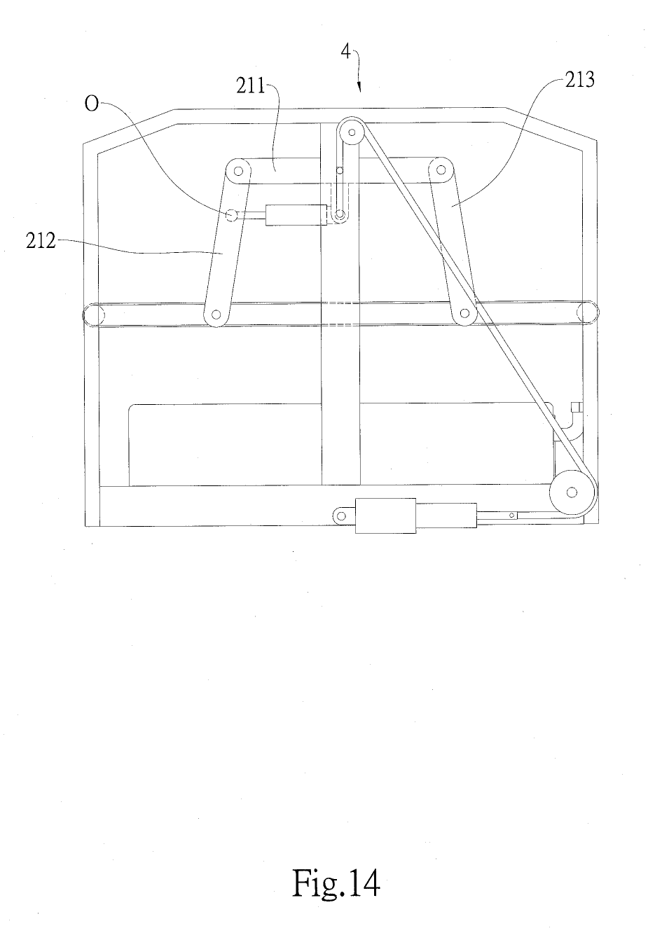

As shown in FIG. 14, the swing driving unit 4 can be a compact oil cylinder O instead of the coil set 41 and the magnet 42. One end of the oil cylinder O is connected to the first rod 211 and the other end of the oil cylinder O is connected to the second rod 212 or the third rod 213 so as to swing the bed board 2.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A swinging water massage bed, comprising:
a bed frame, the bed frame comprising two support posts at two ends thereof, the two support posts each having a shift device thereon;
a bed board provided with two holders at two ends thereof, the two holders being connected to the shift devices of the two support posts, respectively;
an ascent-descent driving unit mounted at one of the two ends of the bed frame, the ascent-descent driving unit being connected with the relative holder through a power driving belt;
a swing driving unit having a coil set and a magnet thereon, the coil set being disposed on the support posts, the magnet being disposed on the holders of the bed board;
a water container disposed in the bed frame and located under the bed board, the water container being filled with liquid;
a water jet device disposed in the water container;
a resilient layer covering the water container; and
a controller electrically connected with the ascent-descent driving unit, the swing driving unit and the water jet device.

2. The swinging water massage bed as claimed in claim 1, wherein the shift device includes at least one slide rail, at least one slide block and a slot, the slot is disposed on the support post, the slide rail is located beside the slot, the slide block is placed on the slide rail, and the holders of the bed board are connected to the slide blocks of the shift devices of the two support posts.

3. The swinging water massage bed as claimed in claim 2, wherein each of the two holders includes a strut to be inserted in the slot, and the power driving belt is connected to the strut.

4. The swinging water massage bed as claimed in claim 3, wherein each of the two holders includes a first rod, a second rod and a third rod, the strut is protruded from the first rod and connected to the slide block, first ends of the second rod and the third rod are pivotally connected to two ends of the first rod, respectively, and second ends of the second rod and the third rod are pivotally connected to the bed board, respectively.

5. The swinging water massage bed as claimed in claim 1, wherein the ascent-descent driving unit includes an oil cylinder, a first driving wheel and a second driving wheel, the power driving belt is connected with the oil cylinder and wound on the first driving wheel and the second driving wheel and connected to the relative holder, the first driving wheel is disposed close to the oil cylinder, and the second driving wheel is disposed above the slot.

6. The swinging water massage bed as claimed in claim 1, wherein the water jet device comprises a guide rod, a first platform and at least one jet nozzle, the guide rod is longitudinally disposed in the water container, the first platform is mounted on the guide rod, and the jet nozzle is mounted on the first platform.

7. The swinging water massage bed as claimed in claim 6, wherein a second platform is provided between the first platform and the jet nozzle, the jet nozzle is disposed on the second platform, a motor is connected to the second platform, and the first platform and the second platform are driven to turn by the motor.

8. The swinging water massage bed as claimed in claim 1, further comprising an air compressor connected to the water container.

9. A swinging water massage bed, comprising:
a bed frame, the bed frame comprising two support posts at two ends thereof, the two support posts each having a shift device thereon;
a bed board provided with two holders at two ends thereof, the two holders being connected to the shift devices of the two support posts, respectively;
an ascent-descent driving unit mounted at one of the two ends of the bed frame, the ascent-descent driving unit being connected with the relative holder through a power driving belt;
a swing driving unit having a compact oil cylinder connected to the holders;
a water container disposed in the bed frame and located under the bed board, the water container being filled with liquid;
a water jet device disposed in the water container;
a resilient layer covering the water container; and
a controller electrically connected with the ascent-descent driving unit, the swing driving unit and the water jet device.

10. The swinging water massage bed as claimed in claim 9, wherein the shift device includes at least one slide rail, at least one slide block and a slot, the slot is disposed on the support post, the slide rail is located beside the slot, the slide block is placed on the slide rail, and the holders of the bed board are connected to the slide blocks of the shift devices of the two support posts.

11. The swinging water massage bed as claimed in claim 10, wherein each of the two holders includes a strut to be inserted in the slot, and the power driving belt is connected to the strut.

12. The swinging water massage bed as claimed in claim 11, wherein each of the two holders includes a first rod, a second rod and a third rod, the strut is protruded from the first rod and connected to the slide block, first ends of the second rod and the third rod are pivotally connected to two ends of the first rod, respectively, and second ends of the second rod and the third rod are pivotally connected to the bed board, respectively.

13. The swinging water massage bed as claimed in claim 9, wherein the ascent-descent driving unit includes an oil cylinder, a first driving wheel and a second driving wheel, the power driving belt is connected with the oil cylinder and wound on the first driving wheel and the second driving wheel and connected to the relative holder, the first driving wheel is disposed close to the oil cylinder, and the second driving wheel is disposed above the slot.

14. The swinging water massage bed as claimed in claim 9, wherein the water jet device comprises a guide rod, a first platform and at least one jet nozzle, the guide rod is longitudinally disposed in the water container, the first platform is mounted on the guide rod, and the jet nozzle is mounted on the first platform.

15. The swinging water massage bed as claimed in claim 14, wherein a second platform is provided between the first platform and the jet nozzle, the jet nozzle is disposed on the second platform, a motor is connected to the second platform, and the first platform and the second platform are driven to turn by the motor.

16. The swinging water massage bed as claimed in claim 9, further comprising an air compressor connected to the water container.
